(19) United States
(12) Patent Application Publication
(10) Pub. No.: US 2007/0158391 A1
(43) Pub. Date: Jul. 12, 2007

(54) Method for joining electronic parts finished with nickel and electronic parts finished with electroless nickel

(76) Inventors: Yoon-Chul Son, Daejeon (KR); Jong-Yeon Kim, Daejeon (KR); Jin Yu, Daejeon (KR)

Correspondence Address: TECHNOLOGY & INTELLECTUAL PROPERTY;STRATEGIES GROUP PC dba TIPS GROUP, P. O. BOX 1639, LOS ALTOS, CA, 94023-1639, US

(21) Appl. No.: 11/590,249

(22) Filed: Oct. 30, 2006

(30) Foreign Application Priority Data
Jan. 12, 2006 (KR) 10-2006-0003616

(51) Int. Cl. A47J 36/02

(52) U.S. Cl. 228/101

(57) ABSTRACT

The present invention relates, generally, to methods for joining an electronic part finished with nickel and an electronic part finished with electroless nickel, which can prevent a brittle fracture, more particularly, to a method for joining an electronic part finished with nickel and an electronic part finished with electroless nickel with a solder by controlling the composition of the solder to prevent a brittle fracture occurring at the solder joining portion.

A method for joining an electronic part finished with nickel and an electronic part finished with electroless nickel, comprising: (1) reflowing solder to a nickel portion of an electronic part finished with nickel to obtain an electronic part where an intermetallic compound and a solder are formed; (2) obtaining an electronic part finished with an eletroless nickel, of which the nickel portion is connected with the solder; and (3) solder-joining an electronic part finished with nickel obtained in the step (1) and the electronic part finished with electroless nickel obtained in the step (2).

### BACKGROUND OF THE INVENTION

1. Field of the Invention

The present invention relates, generally, to methods for joining an electronic part finished with nickel and an electronic part finished with electroless nickel, which can prevent brittle fracture, more particularly, to a method for solder-joining an electronic part finished with nickel and an electronic part finished with electroless nickel by controlling the composition of the solder to prevent brittle fracture occurring at the solder joining portion.

2. Description of the Related Art

As a joining method using solder like flip-chip or BGA package in a package process of an electronic device has a high interconnection density in comparison with a joining method using the existing wire bonding, tape automated bonding (TAB) or lead frame, it has a high efficiency and a short joining distance. Furthermore it loses less electric signals even in a high frequency range, thus it draws an attention as a current and future package technology.

The most important thing in the solder-joining is to form a stable intermetallic compound between solder and under bump metallization (UBM) to secure thermal, mechanical, and electrical reliability.

Lead-tin alloy is used as a representative solder material but the use of lead in an electronic part is controlled and prohibited due to harmfulness. Accordingly, lead-free solders are being continuously developed so that Sn—Ag, Sn—Cu, Sn—Ag—Cu, Sn—Zn, Sn—Zn—Bi series lead-free solders are replacing Pb—Sn.

Meanwhile, UBM for lead-free solder is also developed at the same time so that Cr/Cr—Cu/Cu, Ti—W/Cu/electrolytic Cu, and Al/Ni—V/Cu etc. are used at a chip portion and electrolytic nickel, electroless nickel, organic solderability preservatively (OSP) treated electrolytic nickel are used at a BGA package and a printed circuit board.

The estimation of the foregoing interfacial reaction between a lead-free solder and UBM and its reliability is made by many researchers, copper-based UBM forms a thick intermetallic compound at an interface when it reacts with lead-free solder including a plurality of tins therefore, nickel-based UBM is known to be more appropriate for lead-free solder. In addition, in case that mechanical impact is applied to a solder joining portion, the brittle fracture frequently occurs near the intermetallic compounds formed at the interface and the reliability depends on formation behaviors of intermetallic compounds and the spalling phenomenon to a large extent.

The researches are continued to determine an optimum combination of lead-free solder and UBM. Especially, a joining technology using solder in portable electronic devices having a tendency of high capacity, high function and miniaturization is generalized to ask for the improved reliability to mechanical impact.

### SUMMARY OF THE INVENTION

An object of the present invention is to provide a method for preventing brittle fracture in a package manufactured by joining an electronic part finished with nickel and an electronic part finished with electroless nickel, more particularly, to a joining method for preventing brittle fracture at a solder joining portion when an electronic part finished with nickel and an electronic part finished with electroless nickel are joined by changing the composition of copper included in the joined solder to control the phase and the spalling phenomenon of intermetallic compounds formed on nickel surface layer and electroless nickel surface layer.

In order to achieve the above-identified object, the present invention provides with a method for joining an electronic part finished with nickel and an electronic part finished with electroless nickel, comprising: (1) reflowing solder to a nickel portion of an electronic part finished with nickel to obtain an electronic part where intermetallic compound and solder are formed; (2) obtaining an electronic part finished with eletroless nickel, of which the nickel portion is connected with the solder; and (3) solder-joining the electronic part finished with nickel obtained in the step (1) and the electronic part finished with electroless nickel obtained in the step (2).

In other words, the present invention provides a joining method capable of preventing brittle fracture when an electronic part finished with nickel is joined with an electronic part finished with electroless nickel, including the steps of: forming nickel on a metal wiring of an electronic part at a side; joining solder on nickel layer through reflow process; forming electroless nickel on metal pads on an electronic part on the other side; and joining the electronic parts at both sides by reflowing the solder.

According to the present invention, the content of copper inside the solder used when electronic parts are joined is changed to control formation behaviors of intermetallic compounds formed in the reflow process and the spalling phenomenon, therefore brittle fracture between the electronic parts is avoided.

According to the present invention, an electronic part uses one of a semiconductor chip, a package part and a printed circuit board. In other words, the method for joining electronic parts according to the present invention can be applied to (1) a joining process of a semiconductor chip and a package part (2) a joining process of package parts (3) a joining process of a package part and a printed circuit board and (4) a joining process of a semiconductor chip and a printed circuit board.

In the step (1), intermetallic compound of an electronic part finished with nickel should control the content of copper in the solder to have 0˜0.4 wt % in order to form Ni₃Sn₄ or (Ni,Cu)₃Sn₄ phase.

The composition of the solder of an electronic part finished with nickel and of the solder of an electronic part finished with electroless nickel should be controlled so that the content of copper in the entire solder (32 at FIG. 1) is less than 0.4 wt %, preferably 0.05 to 0.4 wt % when an electronic part finished with nickel and an electronic part finished with electroless nickel are solder-joined in the step (3). If the content of copper in the entire solders is to be less than 0.4 wt %, intermetallic compound of (Ni,Cu)₃Sn₄ is formed on the nickel layer. If intermetallic compounds of (Cu, Ni)₆Sn₅ and (Ni,Cu)₃Sn₄ are formed, brittle fracture generated therebetween can be avoided.

The solder of an electronic part finished with nickel can use Sn—Ag—Cu series solder. At this time, the Sn—Ag—Cu solder used in the electronic part finished with nickel has the composition of Ag of 0˜10 wt %, Cu of 0˜0.4 wt % and the balance of Sn. Meanwhile, the solder of the electronic part finished with electroless nickel may use Sn—Ag—Cu series solder. At this time, the Sn—Ag—Cu solder used in the electronic part finished with electroless nickel has the composition of Ag of 0˜10 wt %, Cu of 0.1˜1.5 wt % and the balance of Sn.

In addition, in case that the solder of an electronic part finished with nickel is Sn—Ag series solder, the solder of the electronic part finished with electroless nickel can use Sn—Ag—Cu series solder and the Sn—Ag solder of the electronic part finished with nickel has the composition of Ag of 0˜10 wt % and the balance of Sn whereas the Sn—Ag—Cu solder of the electronic part finished with electroless nickel has the composition of Ag of 0˜10 wt %, Cu of 0.1˜1.5 wt % and the balance of Sn.

Moreover, in case that the solder of an electronic part finished with nickel is Sn—Ag—Cu series solder, the solder of an electronic part finished with electroless nickel can use Sn—Ag—Cu series solder, and the Sn—Ag—Cu solder of an electronic part finished with nickel has the composition of Ag of 0˜10 wt %, Cu of 0˜0.4 wt % and the balance of Sn, and the Sn—Ag—Cu solder the an electronic part finished with electroless nickel has the composition of Ag of 0˜10 wt %, Cu of 0.1˜1.5 wt % and the balance of Sn.

In the step (1), the solder contacted on the nickel layer should form an intermetallic compound on Ni₃Sn₄ phase, basically. In other words, it is allowed to form (Ni,Cu)₃Sn₄ intermetallic compound including Cu of 0˜0.4 wt % but (Cu, Ni)₆Sn₅ intermetallic compound including Cu of more than 0˜0.4 wt % should not be formed. Likewise, it is possible to contain a small amount (0˜5 wt % per atom) of metal atoms for example, Ni, Au, Pd, In, Sb, Ga, Ge, Bi, Zn, Si and Al within a limit for forming Ni₃Sn₄ phase, besides Ag and Cu in the solder. The suggested composition is Sn of 3.5Ag and Sn-3.0Ag-0.2Cu, etc.

The solder contacted on the electroless nickel layer should include Cu to form Cu—Ni—Sn ternary intermetallic compound (Cu,Ni)₆Sn₅ or (Ni,Cu)₃Sn₄ after reflow is carried out. It is possible to contain a small amount (0˜5 wt % per atom) of metal atoms for example, Ni, Au, Pd, In, Sb, Ga, Ge, Bi, Zn, Si and Al within a limit for forming a Ni—Cu—Sn ternary intermetallic compound, besides Ag and Cu in a solder. The suggested composition is Sn-0.7Cu, Sn-3.0Ag-0.5Cu and Sn-3.5Ag-0.7Cu etc.

The present invention further comprises a step of depositing surface-treated nickel on an electronic part or a metal layer on electroless nickel to improve the wettability with solder and prevents nickel from being oxidized. At this time, a metal layer is deposited with the thickness of less than 1 μm not to change the phase of intermetallic compound in the solder when joining electronic parts. In other words, it is allowed to form (Ni,Au)₃Sn₄ or (Ni,Cu,Au)₃Sn₄ intermetallic compounds including Au, with basically maintaining Ni₃Sn₄ phase on a nickel layer, but it is prohibited an excessive amount of Au from being deposited to be reflowed so that (Au,Ni)Sn₄ intermetallic compound including Ni being Au—Sn intermetallic compound is not formed.

Meanwhile, a metal layer deposited on surface-treated nickel of an electronic part may be formed of one metal selected from the group consisting of gold (Au), silver (Ag), palladium (Pd), Organic Solderability Preservative (OSP), tin (Sn) and tin alloy. At this time, the metal layer deposited on the nickel may be deposited by at least one method selected from the group consisting of electroplating, electroless plating, immersion plating, sputtering and evaporation method. The tin alloy may use Sn—Ag or Sn—Cu.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a process for joining a package part finished with nickel and a printed circuit board finished with electroless Ni(P) including;

(a) forming nickel (14) on a metal wiring (12) of a BGA package (10);

(b) forming Sn-3.5Ag solder (20) on (a);

(c) forming electroless Ni(P) (22) and Sn-3.0Ag-0.5Cu solder (24) on the printed circuit board (18) to be connected with (b); and

(d) joining a BGA package finished with nickel formed in (b) and a printed circuit board finished with electroless Ni (P) by reflow process.

FIG. 2 shows the result of impact tests according to the change of contents of copper inside the lead-free solder.

(a) is a graph showing the number of impact fractures in accordance with the increase of reflow numbers when the contents of copper inside the lead-free solder changes;

(b) is a SEM photograph showing a cross-section toward PCB of a specimen passed the impact tests after the reflow in (1) if the content of copper inside the solder is 0.2 wt % in (a); and

(c) is a SEM photograph showing a cross-section toward PCB of a specimen passed the impact tests after the reflow in (1) if the content of copper inside the solder is 0.5 wt % in (a).

FIG. 3 shows a relationship between spalling behaviors of intermetallic compounds according to the kinds of solder in a printed circuit board finished with electroless Ni(P) and impact tests.

(a) is a graph showing a relationship between spalling behaviors of intermetallic compounds and the number of impact fractures at impact tests;

(b) is a SEM photograph showing a broken cross-section of Sn-3.0Ag-0.5Cu solder of which the number of impact fractures is 240 (The spalling of intermetallic compounds generates about 10% of the total length of a solder pad); and

(c) is a SEM photograph showing a broken cross-section of Sn-36.8Pb-0.4Ag solder of which the number of impact fractures is 70 (The spalling of intermetallic compounds generates about 50% of the total length of a solder pad).

### DETAILED DESCRIPTION OF THE PRESENT INVENTION

A better understanding of the present invention may be obtained in light of the following examples which are set forth to illustrate, but are not to be construed to limit the present invention.

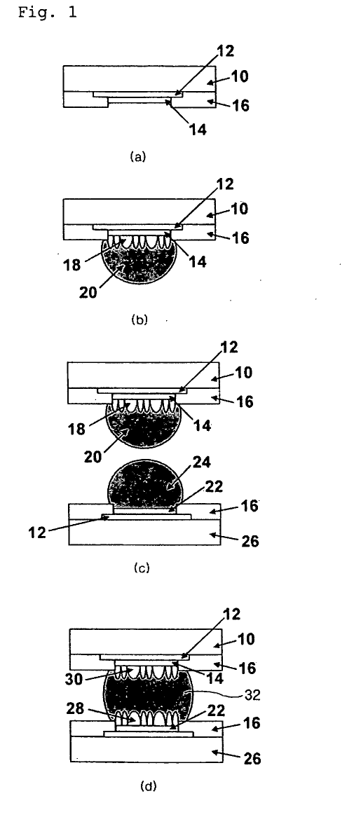

FIG. 1 is a schematic view showing a process for joining a package part finished with nickel and a printed circuit board finished with electroless Ni(P).

First, a nickel layer (14) is formed on a metal wiring (12) of a BGA package (10). (FIG. 1(a)) The nickel layer can be deposited by electroplating, sputtering or evaporation method. Meanwhile, one selected from the group consisting of gold, silver, palladium, OSP, tin and tin alloy may be further deposited on a nickel layer with the thickness of 1 μm in order to improve the wettability of nickel with solder and prevent the nickel from being oxidized.

The lead-free solder (20) of Sn-3.5Ag formed on the nickel layer (14) is reflowed to form an intermetallic compound of Ni₃Sn₄ (18) to prevent brittle fracture occurring from (Cu,Ni)₆Sn₅ or (Ni,Cu)₃Sn₄ intermetallic compounds resulting in keeping parts safely. (FIG. 1(b)) electroless Ni(P) (22) is formed on a metal wiring (12) of a printed circuit board (26) contacting the BGA package (10), on which Sn-3.0Ag-0.5Cu solder (24) is placed to prepare for reflow. (FIG. 1(c)) A solder (24) may be reflowed to form intermetallic compound at an interface. In other words, the solder (24) on the electroless nickel maybe reflowed again when it is joined after being reflowed before it is joined with the electronic part on the opposite side or only when it is joined with an electronic part on the opposite side. At this time, at least one selected from the group consisting of gold, silver, palladium, OSP, tin and tin alloy maybe further deposited on electroless Ni(P) layer with the thickness of less than 1 μm in order to improve the wettability of electroless Ni(P) with solder and prevent the nickel from being oxidized.

Finally, the solder (20) of the upper BGA package (10) and the solder (24) of the lower printed circuit board (26) are reflowed to be joined (FIG. 1(d)). At this time, (Cu,Ni)₆SN₅ and/or (Ni, Cu)₃Sn₄ (28) ternary Cu—Ni—Sn intermetallic compounds are formed at an interface on the electroless Ni(P) phase to prevent the spalling of intermetallic compounds and a brittle fracture. As copper is flowed into a nickel surface via reflow process, the already formed Ni₃Sn₄ intermetallic compounds (18) do not change a phase but can be changed into (Ni,Cu)₃Sn₄ intermetallic compound (30) including copper.

In FIGS. 1(a) through 1(d), the numeral 16 refers to a solder mask. According to the present invention, the lead-free solder adapted to the electroless Ni(P) layer uses Sn—Ag—Cu series and Ag in a soluble range of 0˜10 wt %. The content of copper is adjustable with reference to the content in the entire solder after a package part is joined with a printed circuit board.

For better understandings of the present invention, if the weights of Sn-3.5Ag and Sn3.0Ag-0.5Cu solder applied in FIG. 1 are the same, the content of copper in the entire solder (32) is 0.25 wt % and a kind of (Ni,Cu)₃Sn₄ intermetallic compound is formed on a nickel layer and a Cu—Ni—Sn ternary intermetallic compound is formed on the electroless nickel layer to suppress the spalling of intermetallic compounds and a brittle fracture phenomenon.

A joining between a BGA package and a printed circuit board was described in FIG. 1, but the present invention also can be directly applied in a joining process between electronic parts of the four joinings as follows; (a) a joining process between a semiconductor chip and package parts, (b) a joining process between a package parts, (c) a joining process between a package part and a printed circuit board and (d) a joining process between a semiconductor chip and a printed circuit board, as well as the joining process between a BGA package and a printed circuit board.

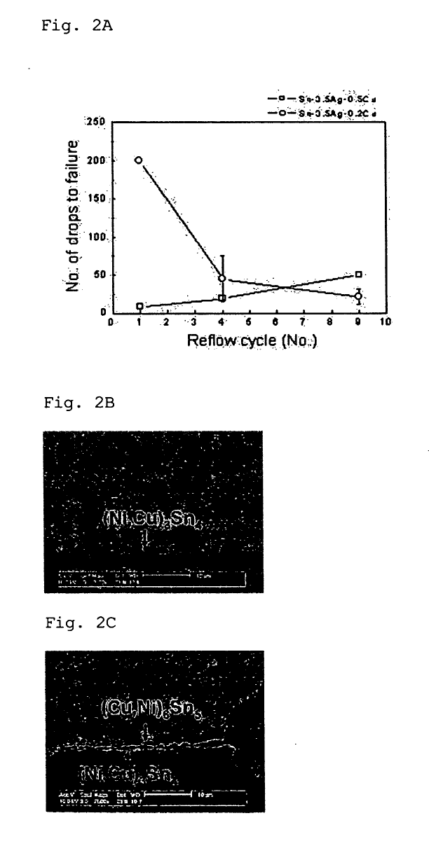

FIG. 2(a) is a graph showing the number of impact fractures in accordance with the increase of reflow when the content of copper inside the lead-free solder.

If the content of copper in the entire solder is 0.2 wt %, the fractures do not proceed up to 200 at the early stage of the reflow. (FIG. 2(b))

However, if the copper in the entire solder is 0.5 wt %, it is confirmed that the fractures proceeded at the interface between (Ni,Cu)₃Sn₄ and (Cu,Ni)₆SN₅. (FIG. 2c))

As the reflow does not last for a long time in a package process for electronic devices, the scope of interests is in estimation of the reliability of reflowed package for a short time.

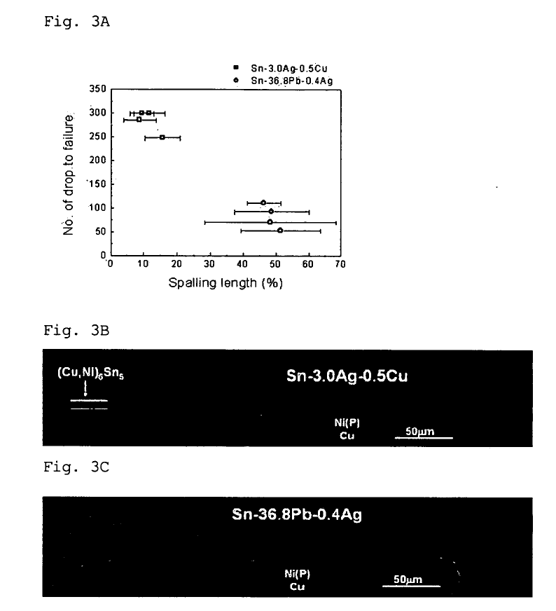

FIG. 3(a) is a graph showing a relationship between spalling behaviors of intermetallic compounds and the number of impact tests in accordance with the kinds of solders in a printed circuit board finished with electroless Ni(P).

FIG. 3(b) is a SEM photograph showing a broken cross-section of a Sn-3.0Ag-0.5Cu solder of which the number of impact fractures is 240 and the spalling of intermetallic compounds generates about 10% of the total length of a solder pad when Sn-3.0Ag-0.5Cu solder is joined with an electroless Ni(P); and

FIG. 3(c) is a SEM photograph showing a broken cross-section of Sn-36.8Pb-0.4Ag solder of which the number of impact fractures is 70 and the spalling of intermetallic compounds generates about 50% of the total length of a solder pad when Sn-36.8Pb-0.4Ag solder is joined with an electroless Ni (P) If a solder includes copper, a layer-tape is used instead of Ni₃Sn₄ compounds and ternary intermetallic compounds such as (Ni,Cu)₃Sn₄ or (Cu,Ni)₆SN₅ with less spalling are formed to increase a resistance to a brittle fracture.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present invention can solve the problems of a brittle fracture which frequently occurs at a joining section when electronic parts are soldered thus, the reliability of electronic devices is guaranteed.

What is claimed is:

1. A method of joining an electronic part finished with nickel and an electronic part finished with electroless nickel, comprising:
(1) reflowing solder to a nickel portion of an electronic part finished with nickel to obtain an electronic part where an intermetallic compound and a solder are formed;
(2) obtaining an electronic part finished with an eletroless nickel, of which the nickel portion is connected with the solder; and
(3) solder-joining the electronic part finished with nickel obtained in the step (1) and the electronic part finished with electroless nickel obtained in the step (2).

2. The method of claim 1, wherein the electronic part is one selected from the group consisting of a semiconductor chip, a package part and a printed circuit board.

3. The method of claim 1, wherein the intermetallic compound formed on an electronic part finished with nickel is a Ni₃Sn₄ or (Ni,Cu)₃Sn₄ phase.

4. The method of claim 1, wherein the solder of the electronic part finished with nickel is a Sn—Ag—Cu series solder having the composition with 0˜10 wt % of Ag, 0˜0.4 wt % of Cu and the balance of Sn.

5. The method of claim 1, wherein the solder of the electronic part finished with electroless nickel is a Sn—Ag—Cu series solder having the composition with 0˜10 wt % of Ag, 0.1˜1.5 wt % of Cu and the balance of Sn.

6. The method of claim 1, wherein the solder of an electronic part finished with electroless nickel is Sn—Ag—Cu series solder, in case that the solder of electronic part finished with nickel is a Sn—Ag series solder; and
wherein the Sn—Ag solder of the electronic part finished with nickel has the composition with 0˜10 wt % of Ag and the balance of Sn, and the Sn—Ag—Cu solder of the electronic part finished with electroless nickel has the composition with 0˜10 wt % of Ag, 0.1˜1.5 wt % of Cu and the balance of Sn.

7. The method of claim 1, wherein the solder of an electronic part finished with electroless nickel is a Sn—Ag—Cu series solder, in case that the solder of electronic part finished with nickel is a Sn—Ag series solder; and
wherein the Sn—Ag—Cu solder of the electronic part finished with nickel has the composition with 0˜10 wt % of Ag, 0˜0.4 wt % of Cu and the balance of Sn, and the Sn—Ag—Cu solder of the electronic part finished with electroless nickel has the composition with 0˜10 wt % of Ag, 0.1˜1.5 wt % of Cu and the balance of Sn.

8. The method of claim 1, wherein the content of copper in the entire solder when an electronic part finished with nickel is joined with an electronic part finished with electroless nickel with solder is in 0.05 wt %˜0.4 wt %.

9. The method of claim 1, wherein the solder on an electroless nickel is reflowed again when it is joined after being reflowed before it is joined with the electronic part on the opposite side or only when it is joined with the electronic part on the opposite side.

10. The method of claim 1, further comprising: depositing a metal layer on nickel or electroless nickel.

11. The method of claim 10, wherein the metal layer is deposited with the thickness of less than 1 μm.

12. The method of claim 10, wherein the metal layer is formed of one metal selected from the group consisting of gold (Ag), silver (Ag), palladium (Pd), Organic Solderability Perservative (OSP), tin (Sn) and tin alloy.
